(19) United States
(12) Patent Application Publication
(10) Pub. No.: US 2012/0326443 A1
(43) Pub. Date: Dec. 27, 2012

(54) VARIABLE SPEED POWER GENERATION FROM INDUSTRIAL FLUID ENERGY SOURCES

(75) Inventors: GINTER Vince, Didsbury (CA); O'NEILL Chris, Calgary (CA); ILLINGWORTH Graham, Calgary (CA)

(73) Assignee: GENALTA POWER, INC., Calgary (CA)

(21) Appl. No.: 13/528,814

(22) Filed: Jun. 20, 2012

Related U.S. Application Data
(60) Provisional application No. 61/499,552, filed on Jun. 21, 2011.

(51) Int. Cl. H02P 9/04; H02K 7/18

(52) U.S. Cl. 290/7; 290/52

(57) ABSTRACT

Method and apparatus are provided for the process optimization of a working fluid stream and energy recovery therefrom. A turbine in the working fluid stream is coupled to a variable speed generator for forming a turbine-generator pair. One controls the turbine speed for affecting the fluid stream for achieving a process objective including controlling fluid process conditions, power generation or both. One can select to achieve a primary process objective with optimization of power generation being secondary. The objectives can be controlled using a base lookup table of turbine performance. Further, actual performance can be gathered for adapting an updated lookup table for better control and optimization. Additional turbine-generator pairs can be arranged in series or parallel for flexible operation and control.

### CROSS-REFERENCE TO RELATED APPLICATIONS

This application claims the benefit of U.S. Provisional Patent application Ser. No. 61/499,552, filed Jun. 21, 2011, the entirety of which is incorporated herein by reference.

### FIELD

The embodiments described herein relate to electrical power generation from the capture of energy from fluid sources found in industry including energy dissipation methods in water distribution; throttling processes, fluid management in chemical, petrochemical, oil and gas production and processing industries. More particularly, electric generators are coupled to fluid-driven devices the speed of which is varied to optimized one or more process parameters or energy objectives.

### BACKGROUND

Electrical power generation using energy conversion devices, such as turbines, that capture energy from natural pressure/flow sources is well established. Some examples of these sources include wind energy, river flows (as in traditional hydro, run of river and pumped storage plants), tidal streams (both impoundment and in-stream schemes) and wave energy.

As the global demand for electricity increases and concern for the environment heightens, additional and new environmentally responsible energy sources and technologies for power generation are being sought. One such source is found from consideration of capturing pressure or flow energy in existing commercial and industrial processes. There are many examples of such sources including: water drop structures or gates used to dissipate energy in irrigation canals, throttling valves used to drop the pressure of gases (such as ethane in the polyethylene production process); throttling valves used to drop the pressure of liquids (such as rich amine in natural gas processing or the manufacture of ammonia); changes in pressure of produced water when it is brought to the surface for processing and then reinserted into the well during oil production; changes in pressure in the rejected concentrate stream of reverse osmosis systems used to desalinate water; cooling water inlets or outlets to large power plants; and flow or pressure control valves in municipal water distribution systems.

Some of these fluid sources are intermittent. The two most notable examples of the current art for exploitation of these types of commercial and industrial sources are natural gas processing and desalination using reverse osmosis. Some natural gas processing plants exist that employ hydraulic power recovery turbines (HPRT) or pressure recovery turbines in a rich amine stream of a sour gas sweetening process. Typically a throttling valve is employed to drop the pressure of the rich amine stream, but these plants instead drop the pressure in the stream across this pressure recovery turbine. Conventionally, the recovered energy is used to drive a lean amine pump by directly connecting the pump and the pressure recovery turbine together. Further, there are many examples of pressure recovery devices in reverse osmosis applications, but again, the energy recovered is used exclusively to directly increase the pressure of the inlet stream.

Applicant understands there to be two main drawbacks to these approaches. First, direct-coupled fluid source-to-fluid end use is a rather inflexible form of energy utilization, particularly when such end use generation equipment needs to be retrofitted to an existing plant. Secondly, since the turbines are typically coupled to the inlet stream pumps, the combined pump/turbine system is intolerant to flow deviations. This is due to the fact that pump performance curves (head versus flow) shift to higher flows when speeds are increased, whereas turbine curves shift to lower flow rates as speeds are increased. It is due to this diverging nature of the performance curves and the fact that changes in flow do occur, that many pressure recovery systems lay unutilized in production facilities today.

There are many turbine manufacturers that can supply custom-designed turbine products resulting in very expensive systems that are not economical for many industrial applications having power outputs ranging from 50 kW to 1000 kW). For high head applications, custom turbines are not readily available, if at all. For very high heads, typically only Pelton wheels can be used, but Pelton wheels appear limited to those open to atmosphere at the outlet and unsuitable for many industrial, closed system applications. Further, such turbine manufacturers appear self-limited to constant speed devices.

Applicant's poll of the pump industry determined that few could provide or were willing to specify or supply pumps to run as turbines instead of pumps. In cases where pumps were indeed located to operate as turbines, typical applications were to couple the turbines directly with to a pump to provide output hydraulic energy in the limited number applications which can utilize hydraulic energy imparted to a related fluid or primary fluid.

### SUMMARY

Generation of power from waste sources is becoming increasingly attractive against a background of rising energy prices and rising energy demand. The economic generation of electric power from waste energy sources can provide local generation of clean, efficient power for many industrial systems and processes, thereby reducing demands on electrical supply grids while also reducing operating costs. One such waste energy source is that of hydraulic pressure in industrial systems where the fluid is required to be at high pressure to achieve a given a first process objective but where the pressure is later reduced to achieve a second objective.

Generally, the shortcomings of the prior art for energy recapture, typically employed for recovering fluid energy to mechanically drive pumps for conversion back to hydraulic energy, have now been addressed using a solution described herein having greater functionality and a wider range of applications. Further, as many industrial fluid energy sources are subject to variable flow or variable head, the energy recovery therefrom is variable.

Simply, fluid energy is recovered and converted to electrical energy, being more flexibly applied to drive pumps in the few cases in which hydraulic energy is desirable, or more flexibly for powering one or more devices for other objectives in the many cases in which energy cannot reliably be re-applied hydraulically. Such systems can be readily retrofitted to existing industrial processes where supplemental hydraulic energy is not easily consumed.

In some embodiments, cost-effective solutions are provided by implementing reverse-running centrifugal pumps despite the scarcity of pump-as-turbine performance data and more particularly so with regards variable speed operation. Further applications with high heads can be implemented through the use of multistage units.

Further, in embodiments, a control system is provided for controlling the generation of power under variable input flow conditions. In addition, control of the turbine speed at the control side permits Applicant to optimize for maximizing power or for firstly for controlling one or more process objectives, with power generation as a secondary consideration.

One or more advantages achieved using one or more embodiments described herein include:
using commercial and industrial sources for generating electrical power;
retrofitting energy recovery to an existing industrial setting heretofore not amenable to such recovery;
utilizing variable speed technology that allows the energy recovery system to run at peak overall efficiency for any given flow rate and differential pressure of the system;
decoupling the generated energy from an electrical grid for removing constraints on turbine control when flow rates happen to vary;
running the variable speed technology at an operating point that maximizes the overall energy captured;
controlling one or more secondary variables including turbine speed, turbine flow rate, turbine or generator shaft torque, system pressure or pressure surges/pulsations, pressure differential across the turbine, upstream or downstream fluid volumes, DC bus voltage, DC bus current, power converter output power, generator frequency; and
controlling the one or more secondary variables as a primary objective while maximizing recovered turbine output power as a secondary objective.

Some processes, which can benefit from variable speed and electrical energy generation and recovery therefrom include closed loop fluid processes including: refrigerant pressure drops in place of expansion valves in conventional refrigeration systems, ethane pressures drops in polyethylene production, natural gas mainline pressure drops; and distribution system pressure drops. Further, the systems can be located in various fluids streams to replace or supplement flow or pressure control valves such as in the above processes or other fluid streams including municipal water distribution systems, produced water from oil and gas wells, elevation differences in storage containers/areas, as well as transport, distribution in chemical petro chemical, oil and gas production and processing industries, pressure drops in natural gas distribution, cooling water inlets or outlets to large power plants, pressure drops in venting of natural gas at oil wells, and drops in irrigation distribution systems.

In one embodiment, a method of fluid energy recovery comprises receiving a fluid flow, such as that having variable pressure or variable flow, at a fluid drive for converting said fluid flow to a rotational output; direct-coupling said rotational output to an electrical generator and regenerative drive; and monitoring one or more process parameters for controlling the speed of the rotational output of the electrical generator to optimize said process parameters. In one embodiment, the process parameters include the head versus flow of the fluid drive and the maximum power point tracking. In another embodiment, the process parameters include the process conditions of the fluid flow to the fluid driver. In another embodiment, the process parameters include the operating parameters of the fluid driver and generator including speed, torque, power, flow rate, head and flow resistance.

In a broad aspect of the described embodiments, a method is provided for the process optimization of a working fluid stream and energy recovery therefrom. The method comprises locating a turbine in the working fluid stream, the fluid stream having one or more variable process conditions and being received at the turbine at a first high pressure. One couples the turbine to a variable speed generator for forming a turbine-generator pair, and drives the turbine with the fluid stream for rotating the turbine at a turbine speed and for the generation of electrical energy from the generator. The fluid stream is discharged from the turbine at a second lower pressure and one controls the turbine speed for affecting the fluid stream for achieving a process objective for at least one of the one or more variable process conditions. In an embodiment, the one or more variable process conditions is selected from the group consisting of a pressure of the first high or second lower pressure, a flow rate of the fluid stream through the turbine and a pressure drop across the turbine. The method can further comprise selecting one of the one or more variable process objectives as a primary process objective, the controlling of the turbine speed further comprising achieving a secondary process objective being to optimize power generation from the turbine while achieving the primary process objective.

In another broad aspect, one controls the speed of the turbine-generator pair for optimizing power generation therefrom. Further, in an embodiment, one improves the power generation by adapting actual performance data to update base turbine performance data, namely by providing a lookup table of turbine performance data; measuring one or more of the one or more variable process conditions for establishing measured process conditions related to a target process objective; selecting a control variable from the lookup table for affecting the measured process conditions; and applying the control variable for controlling the turbine speed to maximize the power recovery. The lookup table can be updated for actual performance data by: gathering actual performance data from the measured process conditions at steady process operation; updating the lookup table for the actual performance data for establishing an updated lookup table; and applying the updated lookup table for controlling the turbine speed for maximizing the power recovery.

A turbine-generator pair can be supplemented with one or more additional pairs in series, in parallel, or in both series and parallel, typically comprising smaller units for replacing the function of one or more throttling or flow control valves. In another broad aspect then, apparatus for process optimization of the working fluid stream comprises: a turbine located in a fluid stream and a variable speed generator, coupled to the turbine for the generation of electrical energy therefrom, the turbine and generator forming a first turbine-generator pair. At least an additional turbine-generator pair is located in the fluid stream upstream of the first turbine-generator pair A first controller controls the speed of the turbine of the first turbine-generator pair, and an additional controller controls the speed of the turbine of the additional turbine-generator pair, the additional controller receiving feedback from the first controller. The first and additional controllers act to control the speed of the turbines of the first and additional turbine-generator pairs for achieving a process objective for at least one of the one or more variable process conditions.

In an embodiment, the first and additional turbine-generator pairs are arranged in series, and in another, in parallel. In another embodiment, the additional turbine-generator pair is a second and a third turbine-generator pair, the second in series with the first pair and the third in a bypass about the first and second pair.

### BRIEF DESCRIPTION OF THE DRAWINGS

FIG. 1 is a chart illustrating the diverging performance of turbine and driven pump systems and incompatibility to speed variations;

FIG. 2A is a block flow diagram of an industrial fluid source integrating one embodiment of fluid source pressure recovery to electrical power generation system;

FIG. 2B is a schematic of a turbine power recovery installation having a bypass about the turbine;

FIG. 3A illustrates a graph of the relationship of flow rate to Head and efficiency for a representative hydraulic turbine at a variety of rotational speeds;

FIG. 3B illustrates a graph of the relationship of flow rate to power for the hydraulic turbine of FIG. 3A at a subset of the rotational speeds;

FIG. 4 illustrates a graph of a family of curves of power vs. rpm for increasing inlet pressure for a representative hydraulic turbine;

FIG. 5 is a graph of a head and power vs. flow rate or rpm illustrating manufacturer's performance curves and actual performance for a representative hydraulic turbine;

FIG. 6A is a block flow diagram of a form of a linear optimal control system applied to the turbine-generator energy recovery system of FIG. 2A;

FIG. 6B is a block flow diagram of the linear optimal control system of FIG. 6A having both feedback to the controller and feedback to the reference generator to update the generator;

FIG. 7A is a schematic of a multistage turbine power recovery installation implementing additional turbine-generator pairs in series with the power recovery installation, and in the bypass of FIG. 2B; and

FIG. 7B is a block flow diagram of a linear optimal control system applied to the multistage turbine power recovery system of FIG. 7A.

### DESCRIPTION

Embodiments herein relate to the recovery of energy from working fluid sources for optional decoupling of such recovered energy from the original fluid system. Herein, working fluids include industrial, commercial and other fluid sources providing fluid energy, characterized by variable pressure and flow. The working fluids streams are constrained, by design, to follow a fluid channel for recovery of energy therefrom. Constrained fluid channels include pipes and conduits used in most closed systems and channels such as in agricultural irrigation. The working fluids are captured herein by conversion devices or drivers such as pumps and turbines. The drivers are directly coupled to electrical generators for decoupling often-times contrary operational characteristics of the conventional driver and an end use device.

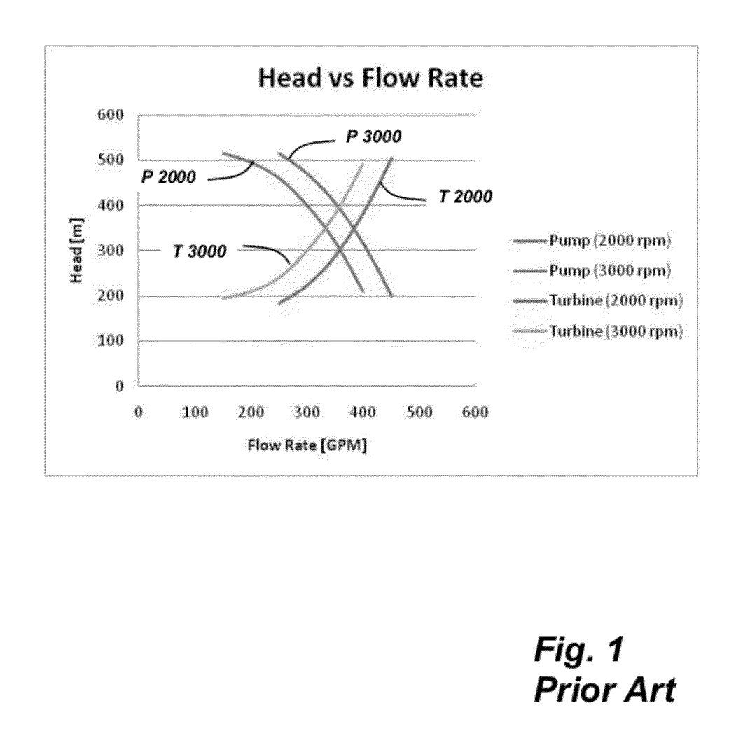

With reference to FIG. 1, in the prior art, a turbine output shaft is coupled directly to a pump drive shaft for energy recovery as hydraulic energy. As shown, such as combined system has a very narrow operating range. This is due to the diverging nature of the performance curves of the individual turbine and pump. As shown, as the pump speed increases, the flow rate for a given head level increases, the head vs. flow rate curve shifting to the right. Conversely, as the turbine speed is increased, the flow passing through the turbine is typically reduced, the head vs. flow rate curve shifting left. This demonstrates the diverging nature of the respective performance curves.

### Turbine Generator System

In an embodiment, Applicant avoids the narrow useful operating range of prior art turbine-pump systems through the connection of a turbine to a compatible electric generator. A centrifugal pump, such as that normally implemented in such industrial pressure/flow sources and run in reverse as a turbine, is connected to a compatible electric generator. Herein the term “turbine” includes any device for converting fluid flow to mechanical output, typically a rotating machine output to a rotating shaft for coupling to other rotary-driven devices. In one embodiment, a pressure recovery turbine is coupled directly through a rotating shaft to an electric generator. As electric generators have very broad efficiency curves, not dependant on flow rate, the combined system maintains an efficiency that is very close to that of the turbine resulting in comparatively broad operating ranges, regardless of variability of either the industrial fluid source, or of the end use.

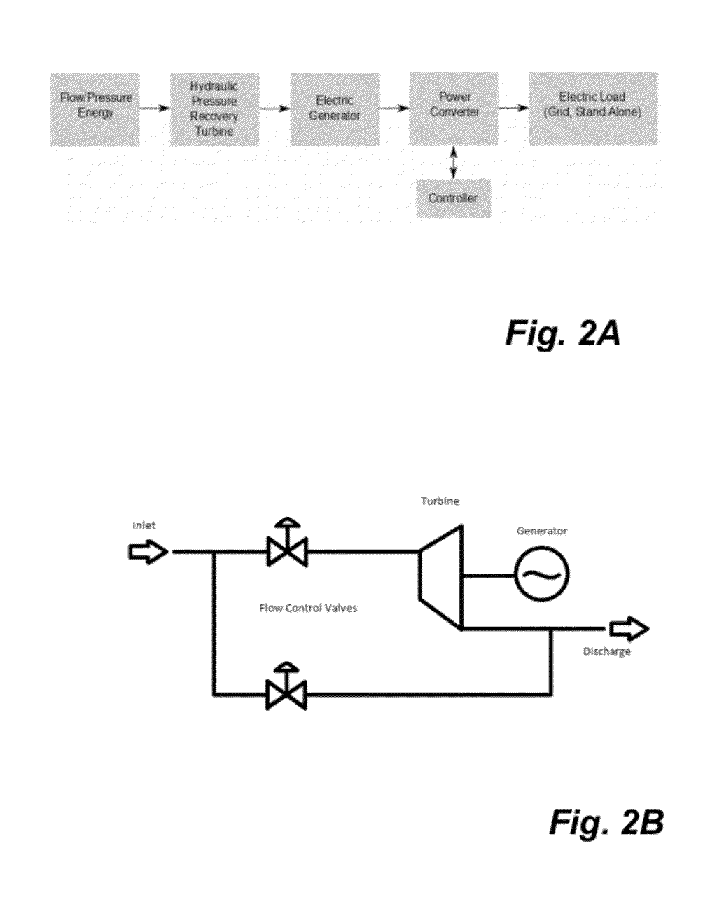

With reference to FIG. 2A, energy from a fluid stream is delivered to the inlet of a turbine for driving the turbine and rotating the turbine at a turbine speed. Turbine output is connected to an electrical generator for the generation of electrical energy therefrom. The connection or coupling of a pressure recovery system to an electric generator provides an efficient means of extracting energy from such flows and one that is readily decoupled from the end use of that energy, thereby eliminating the challenges that can be inherent in direct drive of end-use devices, such as the competing performance curves of turbine-pump pairings. The turbine can be coupled to a generator directly or indirectly, such as through gears, belts, hydrostatic system, or transmission, which maintains flexibility of the end use of the power produced.

The generator output can be directed through a power converter and the turbine-generator operation controlled for achieving certain objectives. The power converter is coupled to an electrical load, being an electrical grid, or standalone device or other electrical destination.

As shown in FIG. 2B, the fluid stream, at a first high head or pressure is directed to the turbine for reduction therethrough to a second lower head or pressure. A bypass can be provided for more flexibility of operation including managing turbine performance including recognizing turbine limitations and process objectives. Flow control valves can be provided in a main fluid stream to the turbine and in the bypass around the turbine. Flow controls may be used as necessary to throttle or bypass flow, despite the opportunity loss for energy recovery. In another embodiment, the flow control valves may be replaced with additional sub-energy recovery systems, such as an additional turbine and generator system of the form described herein.

To provide an even broader operating range as flows change from the design point of the turbine, embodiments herein utilize variable speed technology.

Variable speed is contrary to conventional outputting of electrical power to an electrical grid, having a predetermined grid frequency. Some prior art solutions to variable fluid streams applied to turbines is to provide surge vessels, basins or to throttle the inlet flow with the loss of efficiency associated therewith, all with the objective of ensuring constant generator operation.

To accept fluid streams of variable conditions, the generator of a variable speed system must therefore be decoupled from the grid frequency by means of, for example, a torque converter/hydro-dynamic gearbox or, more typically, power conversion electronics or convertors. Both synchronous and asynchronous generators, when connected directly to the grid, are coupled to the grid frequency. Since the turbine is usually coupled directly to the generator, this could result in a system that rotates at a fixed multiple of the grid frequency at a constant speed. Although by definition, induction generators, being a type of asynchronous generator, turn at a speed that increases slightly from the synchronous speed as it is loaded due to a phenomenon known as slip; for high efficiency generators, slip is typically limited to about 2.5% of the synchronous speed resulting in speeds that change very little and is effectively constant. Accordingly, in an embodiment discussed below, to decouple the generator from the grid frequency, power converters are used as discussed below.

Motor drives, or variable frequency drives, offer a suitable off-the-shelf solution in the power range required, and are readily available; however, the typical unidirectional VFD cannot be used directly since it incorporates a passive rectifier in its design that only allows power transfer in the direction opposite to that needed by a power recovery system supplying power to the grid. One could reverse the connections to the VFD, however, even if the problem of stator excitation in an induction generator is removed, for example by utilizing a permanent magnet style generator, one still encounters the issue of voltage control. Since in this case, the PM generator voltage and therefore DC bus voltage are proportional to generator speed, one cannot maintain a constant voltage at the motor terminals, connected to the grid, without introducing some form of regulator. While these regulators exist, they are complex and are not easily added to an off-the-shelf VFD since they must be put between the passive rectifier and the active bridge.

Another possibility is the use of a bi-directional drive known as a “regenerative” or “4 quadrant” drive. With these drives, the speed of the generator and connected turbine, can be decoupled from the grid frequency while allowing power transfer from the generator to the grid. These regenerative drives use active rectifiers for both the motor and grid side converters allowing bi-directional power flow. Further, AC to AC conversion technology, including resonant converter and matrix converter, or AC to DC to AC conversion technology can be utilized off-the-shelf from solar and wind technology or adapted therefrom. Drawbacks to this approach including harmonic distortion in the waveform exported to the grid due to pulse width modulation (PWM); lack of grid protection functionality; and the requirement for turbine speed control. Harmonic distortion can be mitigated through the use of a grid/load side output filter to remove or significantly reduce unwanted harmonic signal content to standards such as IEEE 519. Such filters are available from electric drive manufacturers. Grid protection can be implemented by using readily available protection relays that can be set to meet IEEE 1547 including for over/under frequency and over/under voltage.

### Turbine Generator Control

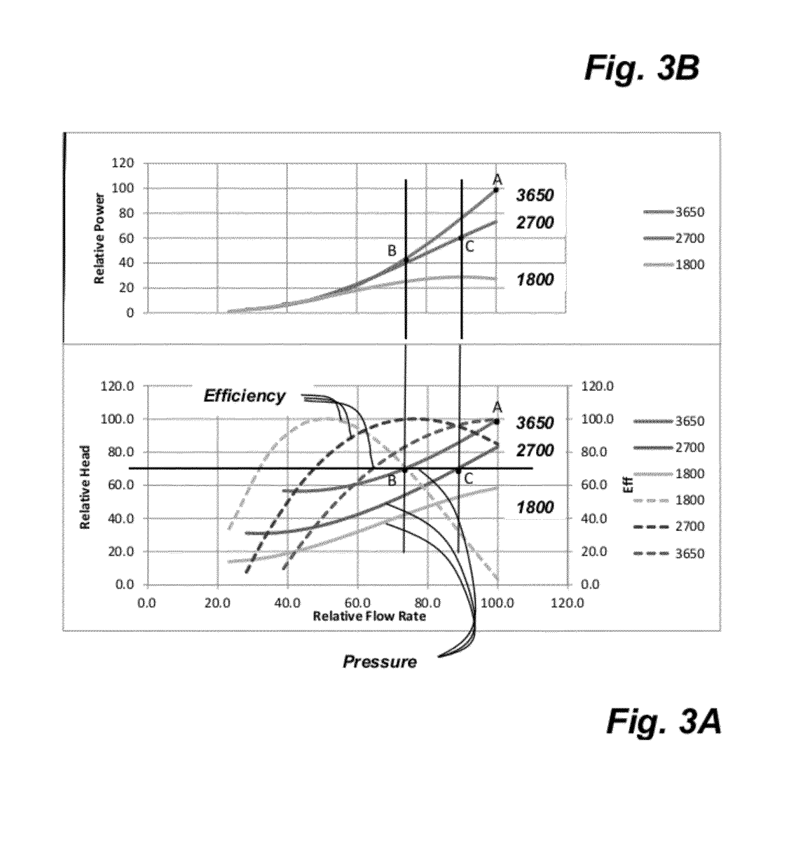

As shown in FIGS. 3A and 3B, turbine speed can be varied to track maximum attainable output power. Further, turbine speed can be varied to track or regulate other variables that are often traditionally thought of as secondary to power generation. Accordingly, in embodiments herein, the system can be designed to achieve process goals as a primary purpose with the generation of electrical power an additional, secondary objective, enhancing system efficiency.

In embodiments, controlling of the turbine speed comprises adjusting a resistive torque to the shaft of the turbine, such as by varying the generator load. In other embodiments, subject to turbine design, turbine speed can be controlled by adjusting the turbine dynamics such as through adjustable blade or impeller angle of attack or through adjustable fluid nozzles. Generally, a minimum turbine speed is maintained to avoid turbine stall.

It is well known among turbine designers that certain turbine variables are uniquely related (speed, torque, power, flow rate, head and flow resistance). Thus, through judicious choice of a control variable such as speed, one can control secondary variables including torque, flow rate, head, and power. Further, through the use of power converters, one also has the choice of certain power converter variables that are related to the turbine variables. Additional variables include generator frequency as related to turbine generator and turbine speed, DC bus voltage related to generator voltage and speed, current related to system torque, and converter power related to turbine shaft power. Certain choices of control variables make it easier to control others. Of course there is the case of multivariable control as well. Therefore, the system can be single input single output (SISO) or multiple input and multiple output (MIMO), or a mixture of the two.

The ability to control a secondary variable is important for applications where other process constraints dominate the objective of maximizing turbine output power. For instance, in the industry of amine processing from gas streams, achieving a specified pressure drop or maintaining the desired fluid level in a contactor can override concerns of power generation and demand that some or all of the power generation capability be sacrificed in favour of maintaining optimal performance in the host process. This can be achieved by modifying the turbine speed which in turn changes the resistance of the turbine to flow and thus its flow rate. Thus in one case, as a process variable, fluid level in the amine contactor will rise or fall to a desired threshold value and the turbine speed is then set to maintain the new level, specifically where flow rate in equals flow rate out. This control scenario is equally applicable in the instances of open tank or storage ponds connected to either the turbine inlet or outlet.

Another example includes the case for a required pressure drop from a fluid flow source such as in a municipal water distribution system. In such cases, the system flow remains essentially constant, and the pressure can be controlled by manipulation of the turbine speed. Consider a Francis turbine operating within such a system; as the turbine speed increases, the pressure head across the turbine increases and vice versa. Thus through active turbine control, the pressure in a system can be precisely controlled

Through this ability to control secondary variables, a much larger range of possible applications is realized for variable-speed-turbine, electrical power generation, and waste energy recovery strategies.

In some systems, there is a desire to control a first high pressure of the fluid stream, such as to maintain the first high pressure for achieving a process objective despite variable inlet flow rates, the flow rate through the turbine being controlled by manipulation of the turbine speed to maintain the first high pressure. The specific effect of turbine speed on the flow and fluid pressure can vary and can be determined from performance data for the turbine.

With reference to FIGS. 3A and 3B, variable speed technology allows a system with a variable energy source to move operating points regardless of the flow regime, such as to maximize efficiency or other process objective. In one example the head to a hydraulic turbine, exposed to a variable head and flow such as a traditional hydro dam, can fluctuate in the order of about 30%.

For a typical reaction turbine, as shown in the response of FIG. 3A, the relative performance characteristics are illustrated as a percentage of rated values at the best efficiency point (BEP) for a constant speed system. At point A, the system operates at the rated values of 100% of the rated head, flow and power. As shown in FIG. 3A, in the case where the head drops from 100% to 70%, then the constant speed system operation will move to point B (70% rated head, 73% rated flow and 42% of the rated power). However, if the turbine speed is also adjusted from 3650 rpm to 2700 rpm, then the operating point moves to point C with a much higher power output of 61%. Thus, for power generation systems with a large amount of variability in the energy source, variable speed systems can significantly increase the total energy extracted over a given time period.

For a typical reaction turbine, for a given first high pressure, illustrated as at a relative head or pressure differential across the turbine of 70%, a decrease in turbine speed from 3650 rpm to 2700 rpm results in an increase in relative flow rate therethrough from about 73% at point B to about 88% at point C. Further, as shown in corresponding graph FIG. 3B, by reducing the speed for this example turbine, the relative power is improved from only about 41 at point B to about 60 at point C.

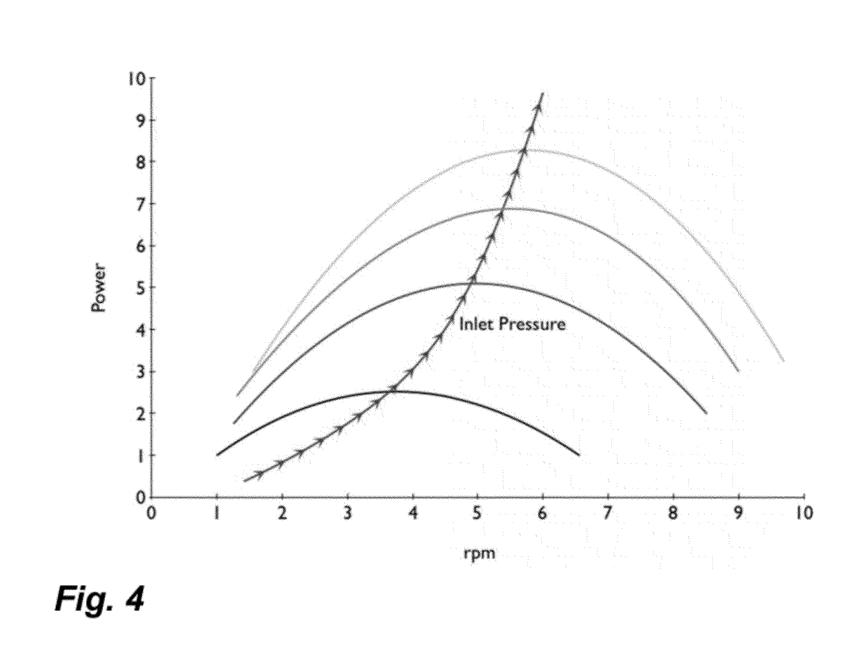

A further illustration is given in FIG. 4 whereby it can be readily seen that a variance in pressure leads to a change in the turbine speed that corresponds to the peak power point for that pressure. A constant speed system would be constrained to operate at a fixed rpm and would be unable to realize the available increase in output power.

To carry out variable speed control, the speed or other related system variable such as torque, power, DC bus voltage, or current is modified to achieve some purpose such as maximizing power generated, regulation of system pressure or control of flow rate. Two general groups of control methods are employed that may also be employed in “layers” so as to optimise the variable of interest as the primary goal and then optimise, for example, power output within the solution space defined by the acceptable tolerance on the primary variable.

One control methodology includes Peak Performance Tracking (PPT) which envelops a group of methods known as perturbation techniques or hill climbing methods. They typically involve the entire class of extremum search algorithms, introducing a perturbation to the system to continuously excite the system to help drive it to the peak performance point. Still others use natural excitation found in the stochastic components of naturally occurring disturbances to the system such as wind turbulence for a wind turbine system. Examples include the use of sinusoidal probing signals with derivative techniques, Fuzzy Logic, Sliding Mode Control, and on/off control. In this instance the “peak performance” point would be the optimum value of the variable of interest and the definition of the “hill” for which the control algorithm attempts to find the peak may be artificially defined within the control logic by the use of a potential function based construct or similar algorithmic approach.

Another control methodology includes Linear Optimal Control (LOC): This group of methods relies on control design techniques that employ a linear model of the system, such as but not limited to PI (Proportional-Integral), H-infinity, gain scheduling, model reference control, or adaptive control, as well as some form of reference generator that tracks the optimum operating points, such as look up tables or mathematical functions defined through detailed knowledge of the system and measurement of a driving variable.

Both of these general approaches optimise the desired output variable for variable speed turbine systems. The benefits of this group of control algorithms are that they require a minimum amount of information about the turbine system, and that they can find the true optimum for the variable of interest. While other schemes can find the theoretical maxima, it is well known that small deviations in mechanical and physical elements of the system, over time, can change the actual optimum operating point. Examples of such real-world deviations include smoothness of surfaces, cavitation erosion, and viscosity changes.

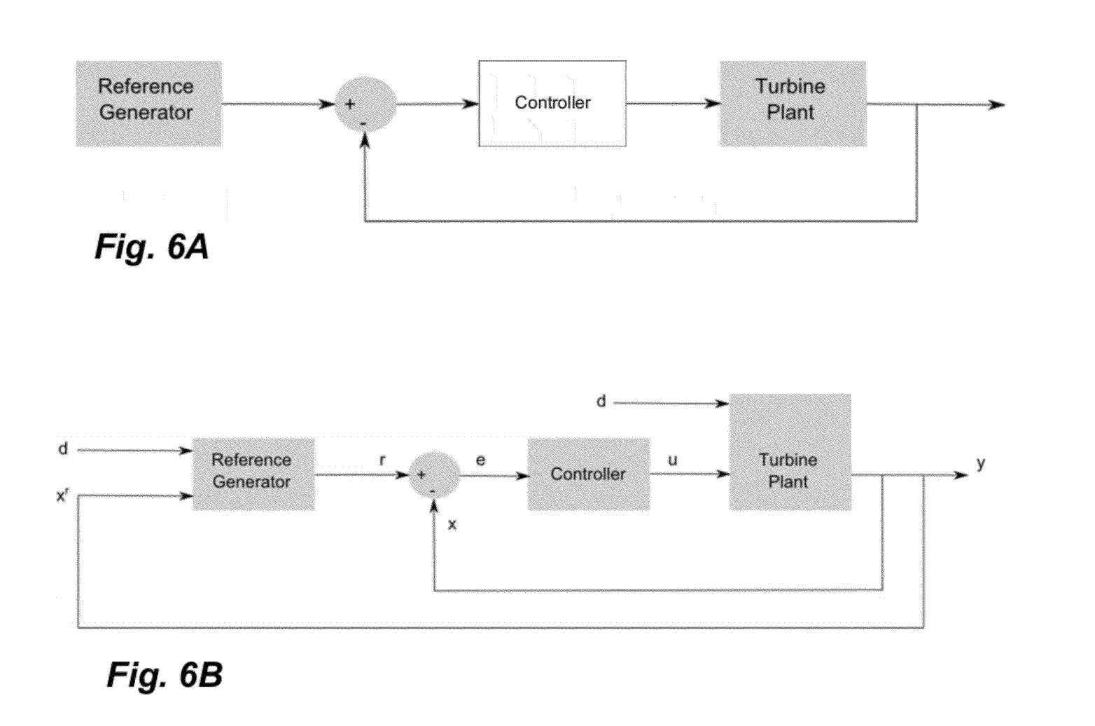

LOC based control systems rely on very detailed information about the turbine-generator system. For simple industrial sources using water or other simple working fluids, attaining this information is straightforward and may be supplied by the component manufacturer. As shown in FIG. 6A such a control methodology is represented, for example the reference generator produces a reference signal to the controller for varying the speed of the generator and coupled turbine for achieving a given objective, such as power maximization. The turbine plant is typically represented by base performance data comprising the turbine manufacturer's published performance curves. Base performance curves include flow rate, speed, head and maximum power points. The performance curves are stored such as in the base lookup table, the values being fed back to adjust the set point such as to adjust the turbine speed for maximizing power at the given head or flow rate.

However, for other sources using complex or dangerous fluids such as rich amine or sulfinol systems found in ammonia production and natural gas processing, this information can be difficult to attain. Manufacturers may test the turbine equipment with water as the working fluid to attain performance curves and other system information but often they will only check the units as pumps, providing turbine performance data from simulations. Even where turbine tests are performed, the results can be significantly inaccurate due to differences in the fluid composition between the test fluid and the working fluid used in actual operation as well as the known phenomenon of evolved gas as fluid pressure is dropped through the turbine stages. Thus, the initial performance information is not as accurate as desired. Thus, the main drawback of this LOC approach is that the manufacturer's data typically provides only theoretical operating values. It also does not account for manufacturing deviations or changes in the system as time moves forward.

Both PPT and LOC approaches have limitations as well as benefits, however by combining these two methods we can impose a control structure that mitigates torsional transients, does not require controller resetting due to instability, and finds the true optimum operating point. To achieve this, the LOC feedback structure is utilized along with a lookup table. However, in the reference generator, elements from both methods are employed.

The first is a base lookup table of values that correspond to the turbine base operating curves under varying flow conditions. This necessary data is normally derived from the turbine system manufacturer's performance tests on water, from which can be extracted or extrapolated the base reference data or base performance curve. The second is a hill climbing PPT algorithm used to adjust the nominal optimum operating points to find the true optimum for the given system in the particular industrial source. In this way the downfalls of both the standard approaches of PPT and LOC are overcome.

Turbine control includes a solution that can be characterized as having two parts: a base control algorithm, and a reference generator.

Applicant has determined the base control algorithm can be handled with standard PI (Proportional-Integral) or PID (Proportional-Integral-Derivative) control for several reasons including the turbine generator system is nonlinear, as well as open loop stable and minimum phase over only part of the operating range. Generally the operation can be restricted to this range. This is due in large part to the fact that any flow rates above the turbine design point can simply be bypassed, such as that shown in FIG. 2B, thus removing the possibility of operation in the open loop unstable, non-minimum phase region; and flow rate changes in an industrial plant are almost always implemented in a smooth fashion so that other sensitive parts of the overall process are not upset. An exception is a process failure resulting in plant shutdown; in which case the generation system would shutdown as well. This fact combined with the low inertia of the turbine generator pair result in a closed-loop feedback process that is less sensitive to relatively small flow induced disturbances.

Even though a fixed-point-control, closed-loop, turbine-system becomes more sensitive in lower flow operating points, such as due to nonlinearities, oscillations in power output in this reduced power range have a much smaller effect on overall power quality with relatively small torsional transients induced in the drive system.

The turbine can be controlled using single or multivariable feedback strategies using any combination of; turbine/generator speed, torque, or power; or variables at the power converter that have analogs to turbine/generator speed, torque and power such as generator voltage, current, or power; DC bus voltage, current, or power, or output current and power. These can be set up as regulation schemes, for driving some value to zero, or set-point or reference schemes.

Thus, the second part of the turbine control solution is the reference generator. While the base control algorithm stabilizes the turbine generator system giving the desired closed loop dynamics, the reference generator is a system that creates the desired reference or set point for the closed-loop system. Without the reference generator, an operator would be required to continuously monitor the system and choose the set-point manually to realize some result.

One such result is producing the maximum power for a given set of operating conditions.

To overcome the problems of basic PPT and LOC, an adaptive lookup approach is employed to update the manufacturer supplied data or base performance curves. The base lookup table comprises the base performance data of flow rate, speed, head and maximum power points. Essentially the installed turbine-generator system is used as a dynamometer to find the peak power points for the different operating regimes realized during normal plant operation. One way to achieve this is to continuously measure and gather actual process conditions or data, or at timed intervals, during normal operation, filtering for values that correspond to steady operation and peak performance. The base lookup table is updated for establishing an updated lookup table of the actual performance data for the actual maximum power points. The turbine speed is controlled from the updated lookup table for optimizing process conditions for a target process objective including optimal power generation.

This embodiment is referred to as passive because no active system control is required to find the points that are used to update the initial base peak performance curve data stored in the lookup table. This embodiment works well in systems with sufficiently large inherent disturbances to move the system to new operating points and sufficiently rapid convergence to steady operation to ensure that the new points lie on the true peak performance curve and may thus be reliably used to update the reference performance data for establishing the updated lookup.

In order to safely update the performance table using the passive method the following three conditions are met: the system must be a steady state operating point; operation must be in the open loop stable region; and the new power value must be greater than the corresponding value in the current lookup table.

A second embodiment uses an active approach to attaining new data, ostensibly by scheduling times when the actual PPT curve can be measured by sweeping the system through a range of steady state operating points for generating actual performance parameters so that the required data can be gathered and a new updated peak performance curve constructed. The table can be updated as often as desired based on the characteristics of the individual energy source and equipment utilized.

The first two conditions for the passive approach, namely steady state and open loop stable operation, also apply to the active method though the last greater value condition need not apply to a properly designed sweep as the risk of inducing instability may be mitigated. For this reason one may employ both methods. For instance in cases where the convergence time of peak performance values for the passive system is suitable on a longer time scale, but not for short term issues, such as the startup of a natural gas processing plant, the passive method can be employed continuously with timed implementations of the active system for more responsive corrections to the PPT curve.

For a system using the passive mode, the system stays in the normal operating mode with the lookup table values being updated at the requested intervals or continuously in a parallel fashion.

Therefore, as shown in FIG. 6B, the system can further utilize an enhanced control methodology including the reference generator and feedback from updating the reference generator to represent actual turbine performance compared to the manufacturer's base turbine performance data. The pump or turbine manufacturer provides the base performance data from which the base lookup table of turbine performance data, describing the characteristic performance of the turbine under varying flow conditions, can be generated. As part of the process conditions, the turbine performance is also measured, such as at the output of the generator for a given pairing of pressure head and fluid flow rate. Actual performance parameters are gathered during normal operation representing actual process conditions. One can filter or otherwise determine the actual performance parameters for steady operation and actual maximum power points achieved. Steady operation is determined using monitoring to avoid transient and other abnormalities in the operation. The actual performance, such as power generated for a given flow rate and turbine speed is used as feedback to the reference generator for updating the base lookup table for the actual performance parameters for the actual maximum power points and creating or establishing the updated lookup table. Accordingly the updated lookup table is used for optimizing process conditions, such as for achieving optimal power generation by controlling turbine speed from the updated lookup table.

As shown in FIG. 6B, the turbine operation is subject to perturbation or a disturbance input d, either as a result of the nature of the industrial fluid stream or perturbation introduced to the system by the control system, exciting the system to help drive it to the peak performance point. The reference generator provides a reference signal r to the controller. Variable u, such as turbine speed, is the variable being controlled, and y is the turbine plant output. The controller provides an error signal e to the controller to adjust the turbine speed u. Monitoring and measurement of the turbine performance provides feedback signals x and x^{r} to the controller and reference generator respectively. Updating feedback signal x^{r} enables updating and adapting of the reference generator for the actual performance.

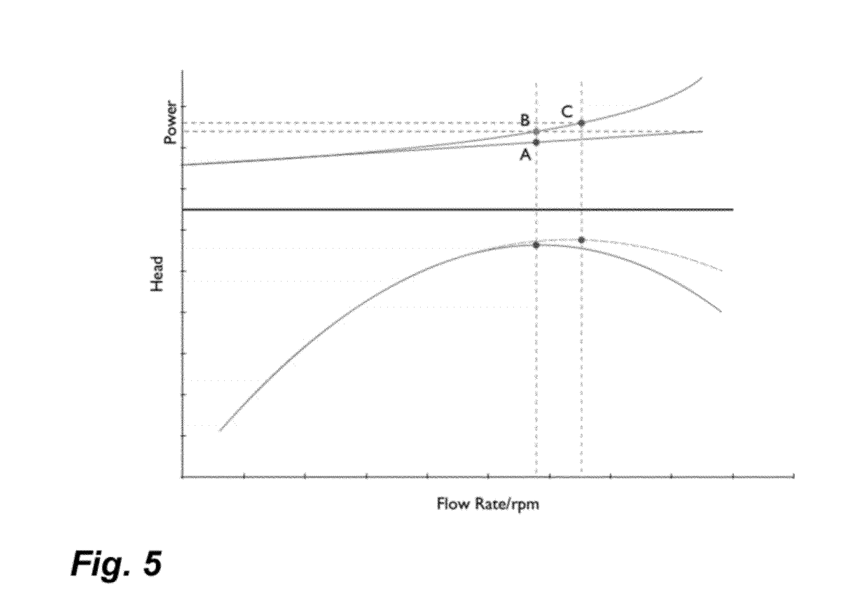

With reference to FIG. 5, a control system believes its turbine is operating along the solid base curve representative of the manufacturer's default performance curve. Similarly, given the manufacturer's default, the system expects that the peak power corresponds to point A. Over time (through active or passive perturbation) the system gathers enough data to confidently predict that the actual turbine characteristic is a modified curve, shown as a dashed curve, having a peak head, efficiency or other characteristic, actually corresponds to point C. One means for determining the new performance is to determine that a measured power output, for example, expected at point A actually turns out to be at point B.

The base curve and modified or updated versions of the performance curves can be stored. One or more of the based or updated performance curves can be stored as a last, good-reference lookup table. As many of the stored curves can used in the scheme as desired. In an embodiment, when the system is upset, either process or control induced, operation can be restored using the last known good-reference table. For systems where the plant and its characteristics can change significantly and require periodic restoration, one might merely store a base curve and a most recent updated curve as the last good-reference table.

For example, in the example of a rich amine stream of a natural gas processing facility, it may occur that a power outage shuts the plant down temporarily. Upon restart of the plant, the amine system is run without sour gas entering the amine system for 10 to 20 minutes. Thus it is prudent to default to the base curve generated from manufacturers performance information derived from testing with water. As the sour gas enters the system, the values can be updated as required.

Further embodiments employ secondary control functions, for example, to optimise the electrical output power within the neighbourhood of a desired pressure control, utilising one or more bypass valves together with one or more pressure reduction or flow control valves to compensate for the effect of operating at an off-peak point. In this manner the system can be used to both achieve a process related goal and, to a lesser extent, to optimise or control a second parameter of interest.

In addition to flow control valves, or as a substitution thereof, one or more additional turbine-generator pairs can be provided for additional fluid stream control and energy recovery.

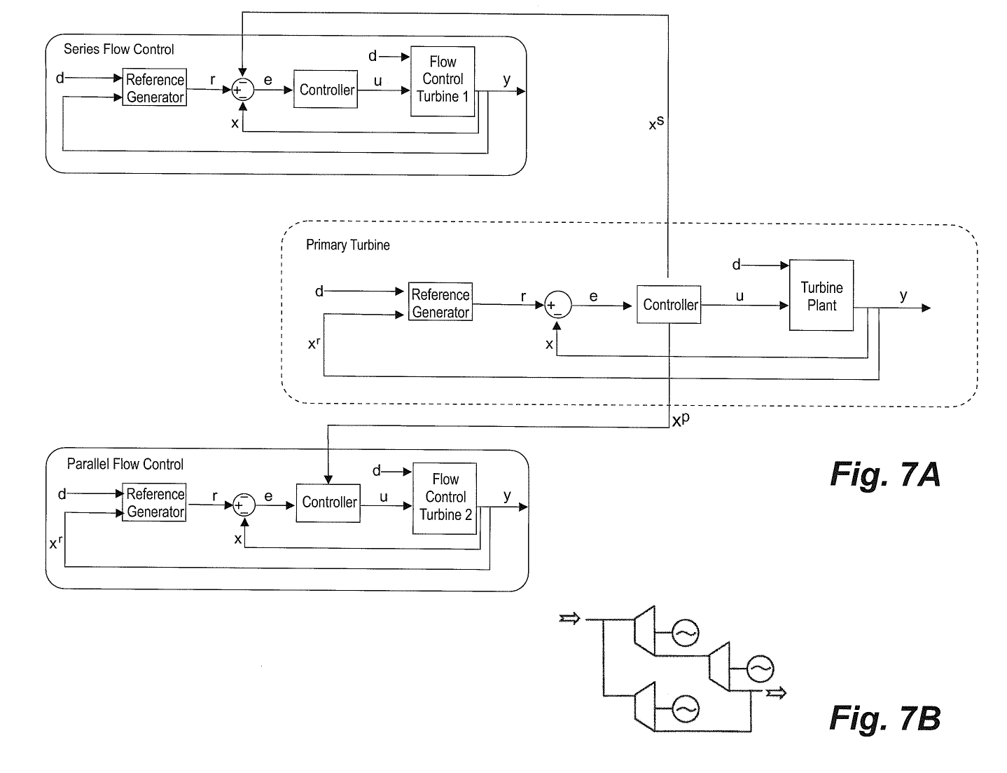

With reference to FIGS. 7A and 7B, for example, a first turbine and first generator can form a first turbine-generator pair as set forth in embodiments described above. A least a second turbine-generator pair is located in the fluid stream upstream of the first turbine-generator pair. Each of the first and additional turbine-generator pairs can include a control system. Each of a first controller and an additional controller can be coupled such as in a cascade control. Alternatively, the action of any or all of the turbine controllers can be controlled or coordinated by a supervisory controller.

As shown, the first controller controls the speed of the turbine of the first turbine-generator pair and the additional, second controller controls the speed of the turbine of the first turbine-generator pair, the additional or second controller receiving feedback from the first controller wherein the first and second controller act to control the speed of the turbines of the first and second turbine-generator pairs for achieving a process objective for at least one of the one or more variable process conditions.

Flow control for the first turbine-generator pair can include a bypass from the inlet to outlet for bypassing at least a portion of the fluid stream about the first turbine-generator pair. The additional or second turbine-generator pair can be located in the inlet to the first turbine-generator pair, arranged in series and may substitute, functionally, for the inlet flow control valve of FIG. 2B. The second turbine-generator pair can also be located in the bypass, arranged in parallel with the first turbine-generator pair. Additional turbine-generator pairs can comprise a second turbine-generator pair in series with the first turbine-generator pair and a third turbine-generator pair in the bypass, arranged in parallel with the first turbine-generator pair.

1. A method for the process optimization of a working fluid stream and energy recovery therefrom, comprising
locating a turbine in the working fluid stream, the fluid stream having one or more variable process conditions and being received at the turbine at a first high pressure;
coupling the turbine to a variable speed generator;
driving the turbine with the fluid stream for rotating the turbine at a turbine speed and for the generation of electrical energy from the generator;
discharging the fluid stream from the turbine at a second lower pressure; and
controlling the turbine speed for affecting the fluid stream for achieving a process objective for at least one of the one or more variable process conditions.

2. The method of claim 1 wherein the one or more variable process conditions is selected from the group consisting of a pressure of the first high or second lower pressure, a flow rate of the fluid stream through the turbine and a pressure drop across the turbine.

3. The method of claim 1 wherein at least one of the one or more variable process objectives is a primary process objective, the controlling of the turbine speed further comprising achieving a secondary process objective being optimize to power generation from the turbine while achieving the primary process objective.

4. The method of claim 1 further comprising:
measuring one or more of the one or more variable process conditions for establishing a measured process condition;
comparing the measured process conditions and a target process objective; and
controlling the turbine speed to achieve the target process objective.

5. The method of claim 4 wherein the working fluid stream resides within a closed loop fluid process.

6. The method of claim 1 wherein the electrical energy from the variable speed generator is directed to an electrical grid, further comprising decoupling the electrical energy from the variable speed generator at a power convertor, and coupling the power convertor to the grid.

7. The method of claim 1 wherein the controlling of the turbine speed further comprises:
providing a base lookup table of turbine performance data;
measuring one or more of the one or more variable process conditions for establishing a measured process condition related to a target process objective;
selecting a control variable from the base lookup table for affecting the fluid stream; and
applying the control variable for controlling the turbine speed to achieve the target process objective.

8. The method of claim 7 further comprising:
gathering actual performance data from the measured process conditions at steady process operation;
updating the base lookup table for the actual performance data for establishing an updated lookup table; and
applying the updated lookup table for controlling the turbine speed for achieving the process objective.

9. The method of claim 1 wherein the controlling of the turbine speed further comprises:
providing a base lookup table of turbine performance data;
gathering performance data at steady operation and updating the base turbine performance data for establishing an updated lookup table of turbine performance data;
applying the updated lookup table for controlling the turbine speed.

10. The method of claim 1 wherein the controlling of the turbine speed further comprises:
providing a base lookup table of base performance data of maximum power points for the turbine;
continuously measuring process conditions indicative of turbine performance for establishing measured process conditions,
gathering actual performance parameters from the measured process conditions during actual process conditions;
filtering the actual performance parameters for steady operation and turbine performance;
updating the base lookup table for establishing an updated lookup table of the actual performance data for the actual maximum power points; and
optimizing process conditions by controlling turbine speed from the updated lookup table.

11. The method of claim 10 wherein the gathering of actual performance parameters from the measured process conditions further comprises:
sweeping the system through a range of steady state operating points for generating actual performance parameters;
filtering the actual performance parameters; and
updating the base lookup table for establishing an updated lookup table of the actual performance data for the actual maximum power points

12. The method of claim 1 wherein the controlling of the turbine speed comprises controlling the turbine speed for controlling the first high pressure or the second lower pressure of the fluid stream.

13. The method of claim 1 wherein the turbine is a reaction-type turbine and wherein the controlling of the turbine speed of the turbine to achieve the process objective comprises increasing the speed of the turbine for increasing the first high pressure.

14. The method of claim 1 wherein the controlling of the turbine speed comprises maintaining a minimum turbine speed to avoid turbine stall.

15. The method of claim 1 wherein the controlling of the turbine speed comprises adjusting a resistive torque to the turbine.

16. The method of claim 15 wherein adjusting the resistive torque to the turbine comprises varying the generator load.

17. The method of claim 1 wherein the controlling of the turbine speed comprises adjusting the turbine dynamics.

18. A method for the recovery of energy from a working fluid stream subject to variable operating process conditions comprising:
locating a turbine in the working fluid stream, the fluid stream having one or more variable process conditions and being received at the turbine at a first high pressure;
coupling the turbine to a variable speed generator;
driving the turbine with the fluid stream for rotating the turbine at a turbine speed and for the generation of electrical energy from the generator;
discharging the fluid stream from the turbine at a second lower pressure; and
controlling the turbine speed for maximizing the recovery of energy.

19. The method of claim 18 wherein the controlling of the turbine speed further comprises:
providing a lookup table of turbine performance data;
measuring one or more of the one or more variable process conditions for establishing measured process conditions related to a target process objective;
selecting a control variable from the lookup table for affecting the measured process conditions; and
applying the control variable for controlling the turbine speed to maximize the power recovery.

20. The method of claim 19 further comprising:
gathering actual performance data from the measured process conditions at steady process operation;
updating the lookup table for the actual performance data for establishing an updated lookup table; and
applying the updated lookup table for controlling the turbine speed for maximizing the power recovery.

21. The method of claim 18 wherein the controlling of the turbine speed further comprises:
providing a base lookup table of turbine performance data of maximum power points for the turbine;
continuously measuring process conditions indicative of turbine performance for establishing measured process conditions,
gathering actual performance parameters during actual process conditions;
filtering the performance parameters for steady operation and actual maximum power points;
updating the base lookup table for the actual performance parameters for the actual maximum power points for establishing an updated lookup table; and
optimizing process conditions for optimal power generation by controlling turbine speed from the updated lookup table.

22. The method of claim 18 wherein the electrical energy from the variable speed generator is directed to an electrical grid, further comprising decoupling the electrical energy from the variable speed generator at a power convertor, and coupling the power convertor to the grid.

23. Apparatus for process optimization of a working fluid stream having one or more variable process conditions and for the recovery of energy therefrom, comprising:
a turbine located in a fluid stream and a variable speed generator, coupled to the turbine for the generation of electrical energy therefrom, the turbine and generator forming a first turbine-generator pair;
a least an additional turbine-generator pair located in the fluid stream upstream of the first turbine-generator pair;
a first controller for controlling the speed of the turbine of the first turbine-generator pair;
an additional controller for controlling the speed of the turbine of the additional turbine-generator pair, the additional controller receiving feedback from the first controller wherein
the first and additional controllers act to control the speed of the turbines of the first and additional turbine-generator pairs for achieving a process objective for at least one of the one or more variable process conditions.

24. The apparatus of claim 23 wherein the least a second turbine-generator pair comprises a second turbine pair further comprising:
an inlet to the first turbine-generator pair and an outlet from therefrom, and
wherein the second turbine-generator pair is in located in the inlet.

25. The apparatus of claim 23 wherein the least a second turbine-generator pair comprises a second turbine-generator pair further comprising:
an inlet to the first turbine-generator pair and an outlet from therefrom; and
a bypass from the inlet to outlet for bypassing at least a portion of the fluid stream about the first turbine-generator pair,
wherein the second turbine-generator pair is in located in the bypass.

26. The apparatus of claim 23 wherein the least a second turbine-generator pair comprises a second turbine-generator pair and a third turbine-generator pair, further comprising
an inlet to the first turbine-generator pair and an outlet from therefrom; and
a bypass from the inlet to outlet for bypassing at least a portion of the fluid stream about the first turbine-generator pair,
wherein the second turbine-generator pair is in located in the inlet.
wherein the third turbine-generator pair is in located in the bypass.

27. The apparatus of claim 26 wherein the bypass from the inlet is upstream of the second turbine-generator pair.

28. The apparatus of claim 23 wherein the actions of the turbine controllers are coordinated by a supervisory controller.
